(19) United States
(12) Patent Application Publication
(10) Pub. No.: US 2012/0010926 A1
(43) Pub. Date: Jan. 12, 2012

(54) Systems and Methods for Compensating Participants in a Multi-Level Marketing Plan

(76) Inventor: Joseph P. Urso, Dallas, TX (US)

(21) Appl. No.: 12/831,892

(22) Filed: Jul. 7, 2010

(51) Int. Cl. G06Q 10/00; G06Q 90/00

(52) U.S. Cl. 705/7.42

(57) ABSTRACT

The present disclosure generally provides systems and methods for compensating participants of a multi-level marketing plan. A participant occupies a top position of a placement tree that has a binary structure and a top position of an enrollment tree that has a unilevel structure. Each member personally sponsored by the participant occupies a first level and each subsequent member personally sponsored by that member occupies a second level. A first distributor is classified as occupying a first lower position of the placement tree and is also classified as occupying a first lower position of the enrollment tree. A team bonus of the first distributor is determined based on revenue generated by sales made by members of the placement tree down line from the first distributor. A matching bonus is determined based on the team bonus of the first distributor, regardless of the enrollment tree level of the first distributor.

### TECHNICAL FIELD

The present disclosure generally relates to multi-level marketing plans, and more particularly to systems and methods for compensating participants in a multi-level marketing plan.

### BACKGROUND

Multi-level marketing (MLM) is often used by companies to sell products and/or services to consumers. In a typical situation, multi-level marketing employs a business distribution model, which allows a company to market its products and/or services to consumers using referrals and direct selling. Individuals are compensated based on their sales of a product and/or service, as well as the sales achieved by those they bring into their organization within the business. Some examples of multi-level marketing organizations may be found in U.S. Pat. Nos. 7,149,707 (“Scoble”) and 6,691,093 (“Shell”); and U.S. patent application Ser. Nos. 11/369,533 (Pub. No. U.S. 2006/0235749) (“Moc”); 12/044,786 (Pub. No. U.S. 2008/0221994 A1) (“Rutz et al.”), 12/117,894 (Pub. No. U.S. 2008/0281681 A1) (“Bremner et al.”).

Individuals that are part of a multi-level marketing structure or plan may be referred to as distributors, field representatives, salespeople, etc., and are generally rewarded a commission relative to the volume of products and/or services sold through each of their independent businesses. Individuals develop their organizations by either building an active customer base and/or by recruiting a down-line of independent distributors who also build a customer base, which expands the overall organization. Further, distributors can also earn a profit by selling products and/or services, which they purchased from the parent company at a wholesale price.

Distributors earn a commission based on the sales efforts of their organization, which includes their independent sales efforts as well as the leveraged sales efforts of their down-line. Commissions are paid to multi-level marketing distributors according to the company's compensation plan. Multi-level marketing organizations may be organized in a unilevel structure, a binary structure, or a hybrid structure. In a unilevel structure, all of a distributor's personal recruits into the organization are positioned on the first level of the unilevel structure. If these people recruit others, those others are positioned on the original distributor's second level, and so on. In a binary structure, the number of distributors on each level is limited to a fixed number. Thus, each distributor may have two recruits directly under him in a binary structure. Others recruited by the original distributor may be placed further down in the tree. Compensation is awarded based, at least in part, on a distributor's position in either the unilevel or binary structure. In a hybrid structure, compensation of a particular distributor may be based on an individual distributor's position in both a unilevel and a binary structure.

### SUMMARY

Embodiments of the present disclosure generally provide a method of compensating a participant of a multi-level marketing plan. The method includes classifying a participant as occupying a top position of a placement tree associated with the participant. The placement tree has a binary structure. The participant is also classified as occupying a top position of an enrollment tree associated with the participant. The enrollment tree has a unilevel structure. In this structure, each member personally sponsored by the participant occupies a first enrollment tree level and each member personally sponsored by each member personally sponsored by the participant occupies a second enrollment tree level. A first distributor is classified as occupying a first lower position of the placement tree associated with the participant and is also classified as occupying a first lower position of the enrollment tree associated with the participant. A team bonus of the first distributor is determined based on revenue generated by sales made by a plurality of members of the placement tree associated with the participant down line from the first distributor. A matching bonus is determined based on the team bonus of the first distributor where the first distributer may occupy any level of the enrollment tree associated with the participant. The team bonus is distributed to the first distributor, and the matching bonus is distributed to the participant.

In one embodiment, the systems and methods of the present disclosure provide incentive for members of a multi-level marketing organization to personally recruit others into the multi-level marketing organization.

Also, embodiments of the present disclosure provide systems and methods to allow a participant of a multi-level marketing organization to earn compensation on the sales of other members directly down line of the member, regardless of their level in a unilevel tree structure. This may also eliminate the need for a unilevel tree structure to break off at a certain level beyond which the participant would earn no compensation. Furthermore, if a member of the unilevel tree structure becomes inactive, the need for compression of the active members below the inactive member in the unilevel tree structure may be eliminated.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 is a schematic drawing of an enrollment tree showing a multi-level marketing sales force having a unilevel structure according to an embodiment of the present disclosure;

FIG. 2 is a schematic drawing of a placement tree showing a multi-level marketing sales force having a binary structure according to an embodiment of the present disclosure;

FIG. 3 is a flow diagram illustrating a method of compensating a participant of a multi-level marketing plan according to an embodiment of the present disclosure;

FIG. 4 is a flow diagram illustrating a method of computing compensation for a participant of a multi-level marketing plan according to an embodiment of the present disclosure; and

FIG. 5 is a schematic block diagram of a computer system on which embodiments of the present disclosure may operate.

### DETAILED DESCRIPTION

The present disclosure generally provides systems and methods for compensating distributors or participants in a multi-level marketing plan. Throughout this disclosure the terms “participant,” “member,” and “distributor” may be used to denote an individual who participates in a multi-level sales force that markets and sells products and/or services provided by a company. The teachings of the present disclosure employ features of a unilevel tree structure and a binary tree structure to allow compensation of distributors in a multi-level marketing plan that provide incentive for the participants to sell products provided by the company and also to recruit others into the multi-level marketing sales force. Multi-level marketing, network marketing, or direct selling describes a method of selling products, goods, and/or services through a network of sales people that earn overrides or commissions on sales made by other people they recruit into their sales team as well as their own sales.

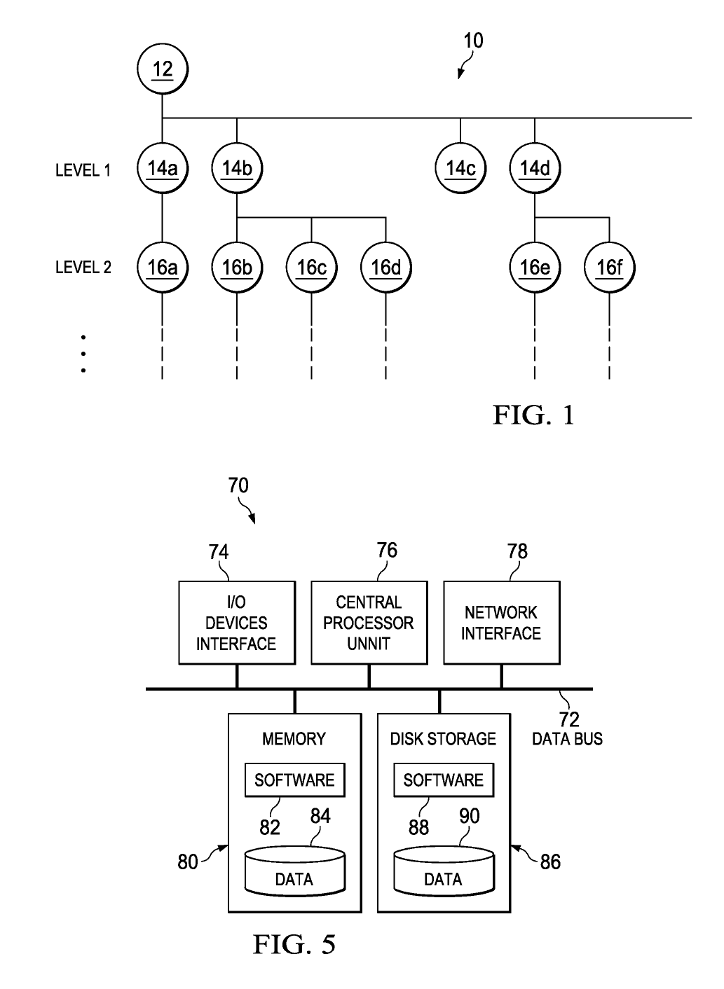

It should be understood that the tree structures, flow charts, and schematic diagrams shown in FIGS. 1-5 are for illustrative purposes only and that any other suitable systems or methods could be used in conjunction with or in lieu of the illustrated tree structures, flow charts, and schematic diagrams according to embodiments of the present disclosure.

Unilevel Enrollment Tree

Referring to the drawings, and particularly to FIG. 1, an enrollment tree 10 structure of the multi-level marketing plan is shown. The enrollment tree 10 is structured in a unilevel structure, with each circle of FIG. 1 representing a member, distributor, or participant in the enrollment tree 10. A participant 12 is at the top of the enrollment tree 10. Since participant 12 is at the top of enrollment tree 10, it can be said that enrollment tree 10 is the participant's 12 enrollment tree 10. Each of the members below the participant 12 of the enrollment tree 10 may be said to be in direct downline with participant 12. In this configuration, all of the members that the participant 12 personally recruits into the multi-level marketing plan (14a, 14b, 14c, and 14d) are positioned on the first level of the enrollment tree 10. If these people also recruit other people they would fall on the participant's 12 second level, and so on. Thus, in FIG. 1, member 16a is shown as having been personally recruited by member 14a, and member 16a is classified as being on level 2 of the enrollment tree 10. Similarly, members 16b, 16c, and 16d have been personally recruited by member 14b, member 14c has not recruited any members, and member 14d has personally recruited members 16e and 16f. Each of members 14a, 14b, 14c, and 14d are classified as being on the first level of the participant's 12 enrollment tree 10, and each of members 16a, 16b, 16c, 16d, 16e, and 16f are classified as being on the second level of the participant's 12 enrollment tree 10. The enrollment tree 10 can extend to include additional members personally recruited by any of the members shown in the enrollment tree 10, which can include members personally recruited by members 16a, 16b, 16c, 16d, 16e, and 16f, which would occupy the third level of enrollment tree 10, and so on, as indicated by the dashed lines of FIG. 1.

Conventional compensation for the participant 12 from the sales of the members of the enrollment tree 10 decreases as the members are removed from participant 12 and occupy higher levels of the enrollment tree 10. For example, participant 12 may earn 10% of the sales of those members of the first level of the enrolment tree 10 (14a-d), and participant 12 may earn 5% of the sales from those members of the second level of the enrollment tree 10 (16a-f). In the conventional model, this decreasing earning percentage as the levels of enrollment tree 10 increase may ultimately result in a level at which participant 12 will earn nothing on the sales of the members of, for example, level 7, and the enrollment tree 10 will be said to break off at level 7. Also in conventional multi-level marketing compensation models, if a member occupying a lower level of the enrollment tree does not maintain certain purchasing and/or selling requirements, he may be deemed to be inactive. In this case, the enrollment tree may compress such that those members below the inactive member in the enrollment tree will move up to occupy his position in the enrollment tree. For example, the member 14d may have failed to meet his purchasing and/or sales requirements for the time period in question. Thus, member 14d will be determined to be inactive, and members 16e and 16f will move to level one of the enrollment tree.

Binary Placement Tree

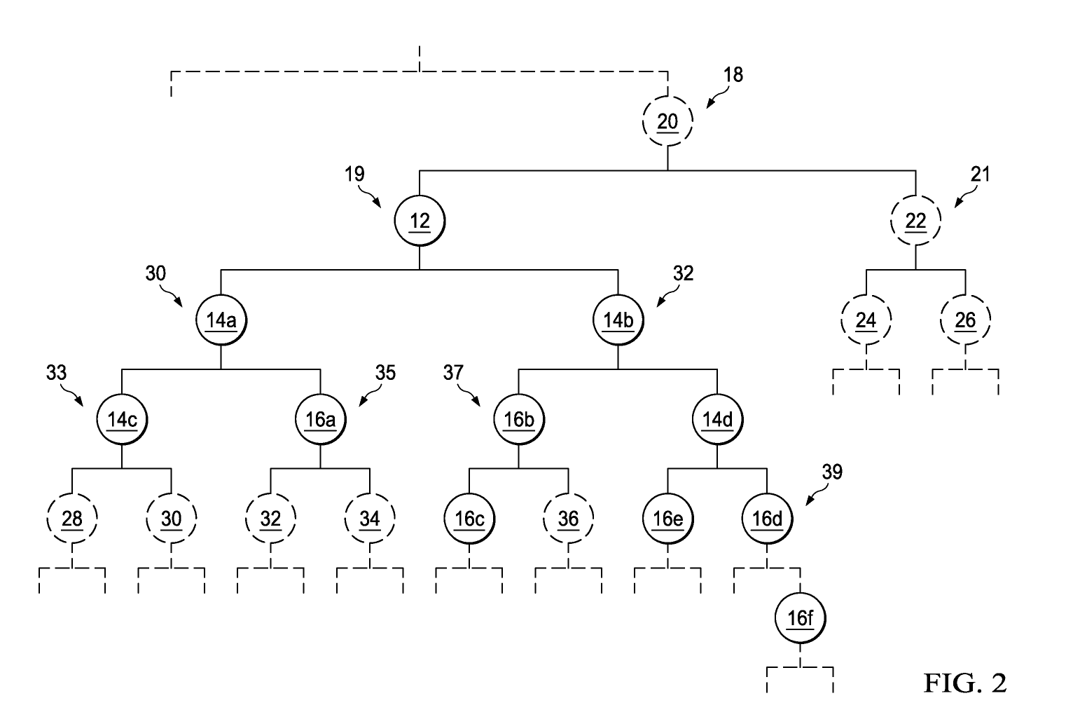

FIG. 2 is an illustration of a placement tree 18 according to an embodiment of the present disclosure. Each of the members shown in the enrollment tree 10 of FIG. 1 is illustrated in the placement tree 18 of FIG. 2. The placement tree 18 is in a structure known as a matrix structure. The particular matrix structure shown is a “two-by” matrix, which may also be referred to as a binary structure. In this type of configuration, the number of sales people or members directly below any single member is limited to a fixed number, for example two. In addition, levels are typically not as important in the binary structure because a member typically earns the same percentage of sales made by each member in that member's direct downline.

FIG. 2 represents a placement tree portion 18 of a placement tree that includes every member of the multi-level marketing sales force of the company. The additional members not shown are indicated by the dashed lines extending above and below the members illustrated on the placement tree 18 of FIG. 2. Similar to the enrollment tree 10 of FIG. 1, it can be said that the participant 12 occupies a top position of the participant's 12 placement tree 19. The placement tree 19 includes each member personally sponsored by the participant 12, as shown in FIG. 1. These members are illustrated with circles with a solid line. In addition, because in this embodiment the placement tree 18 is in a binary structure, participant's 12 placement tree includes two legs—a left leg 30 and a right leg 32. The left leg 30 and/or the right leg 32 may be referred to as the greater leg, if the collective sales of its members exceeds the collective sales of the members of the other leg in any given time period, for example one week. The other leg may be referred to as the lesser leg for that particular week.

Some unique features to this type of binary structure are that when a person recruits more than two people, the extra people have to be placed on a lower level, and spillover under previously sponsored members. For example, if the participant 12 personally sponsors four members (14a-d), this sales team may look like the placement tree 19, in which the third member 14c is not placed on a level directly under the participant 12, who recruited him/her (because that level is full) but rather is placed on the next lower level. In addition, the participant 12 can earn compensation from the sales of members in his placement tree 19 that he did not personally recruit. For example, members 28, 30, 32, 34, and 36 were not personally recruited by participant 12 (as indicated by the circles of dashed lines), yet the system has placed them in the participant's 12 placement tree 19. These members (28, 30, 32, 34, and 36) could have been personally recruited by a distributor above or below the participant 12 in the placement tree of the company. For example, any one of members 28, 30, 32, 34, or 36 may have been personally recruited by member 20 or a member above him in the placement tree of the company and placed in the participant's 12 placement tree by the system. Moreover, the member 14a may have personally recruited member 28, who is also classified as occupying a position in the participant's 12 placement tree 19.

In accordance with an embodiment of the present disclosure, the system may select a location for a member 28 on the placement tree 19 that maximizes the compensation earned by the member that personally sponsored the member 28. As shown in FIG. 1, the participant's 12 placement tree 19 is illustrated as the left leg of the member's 20 placement tree 18, which has a right leg 21 with a member 22 at its top.

Compensating an MLM Participant

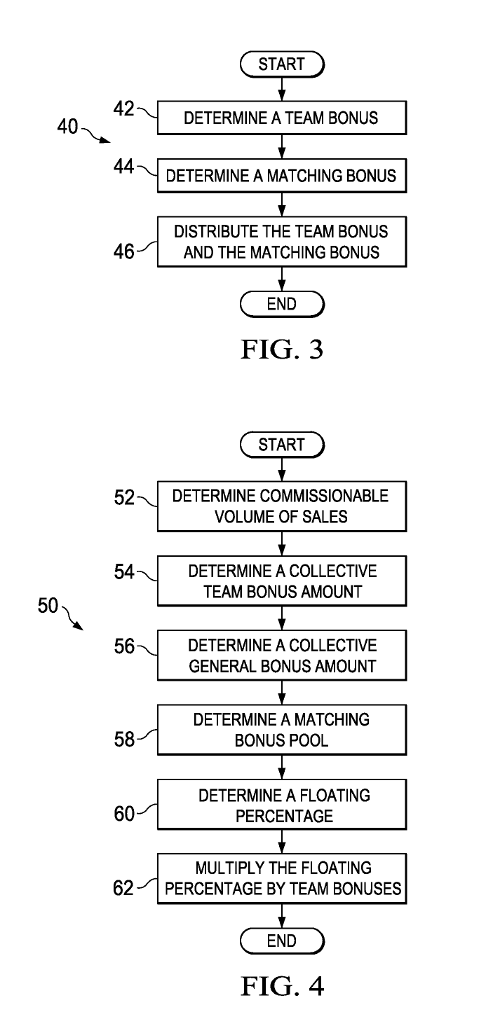

FIG. 3 is a somewhat simplified flow diagram illustrating method 40 of compensating a participant of a multi-level marketing plan. It should be understood that the method 40 shown in FIG. 3 is for illustrative purposes only and that any other suitable method or sub-method could be used in conjunction with or in lieu of method 40 according to an embodiment of the present disclosure. It should also be understood that the steps of method 40 could be performed in any suitable order or manner.

The method 40 begins at step 42 where a team bonus is determined. For example, the participant 12 may earn a team bonus from the sales of the members in his direct downline of his placement tree 19 (see FIG. 2). Note that members of the participant's 12 direct downline may not have been personally sponsored by participant 12 (i.e. members 28, 30, 32, 34, and 36).

In certain embodiments, revenue earned by a member through sales of the company's products and/or services may be counted in units other than dollars. This may make it easier for the company to adjust the price of a product or service without having to modify its multi-level marketing compensation plan to reflect the new price of an item. For example, sales personally attributed to a member may be measured in units of personal volume (“PV”). A personal volume unit may approximate the profit earned on the sale of an item. For example, if a member of the multi-level marketing organization purchases a product from the company at a wholesale price of $300 and the sales price of the product is $500, the member would earn 200 PV. As will be described below, members can also earn compensation on the sales of members down line in either his enrollment tree (unilevel) or his placement tree (binary). The collective personal volume of members downline of a participant may be referred to as the participant's group volume (“GV”). Thus, for example, as shown in FIG. 2, if members 14a and 14c each have a PV of 200 over a given time period, then participant 12 may be determined to have a 400 GV in his left leg 30 of his placement tree 19. The collective PV of members 14a and 14c may also count towards any compensation earned through the enrollment tree 10 of participant 12 (shown in FIG. 1).

To earn certain compensation, the participant 12 may be required to meet certain minimum criteria. For example, to earn certain compensation the participant 12 must be active. In certain embodiments, the participant 12 is active if he has a minimum PV, such as 100, over a predetermined time period, for example four weeks. Certain compensation may also be awarded when the participant 12 is qualified. To be qualified, the participant 12 may be required to have at least one personally sponsored and active member in each of his left and right legs 30 and 32 of his placement tree 19 (FIG. 2).

In certain embodiments, to earn the team bonus, the participant 12 may be active and qualified with a minimum GV, such as 500, in each of his left and right placement tree legs 30 and 32 for a predetermined time period, for example one week. The team bonus may be 10% of the group volume of the lesser leg. In certain embodiments, this value may be computed by calculating 5% of the group volume of the lesser leg and adding 5% of an equal group volume in the greater leg. In this instance, any unused group volume from participant's 12 greater leg may be preserved and roll into the next time period, provided the participant 12 stays active. The team bonus may be capped at a certain value for a selected time period. For example, the team bonus may be capped at $10,000.

Similar to participant 12, members 14a and 14b may each earn team bonuses on their respective left legs 33, 37 and right legs 35, 39. For example, member 14a may earn a team bonus computed from 10% of his lesser leg's sales. Thus, if member's 14a left leg 33 is the lesser leg, member 14a may earn 10% of the sales of members of his left leg 33. Similarly, member 14b may earn a team bonus based on sales of his lesser leg out of his left and right legs 37, 39. The teachings of the present disclosure are not limited to the caps and percentages included in the examples provided. Rather, in certain embodiments, any suitable value of bonus caps and any suitable percentage of sales may be used in computing compensation according to the present disclosure. As members move up in rank, they may be required to meet higher minimum values of GV and/or have distributors that have higher ranks in one/or more of the legs of their enrollment or placement trees. Also, members may earn ranks lower than “executive” by reaching goals that are more easily achieved, such as having a minimum of 500 GV in their lesser leg for a certain period, such as one week. This rank may be reached without any requirement that a member in a placement tree achieve a certain rank. In a multi-level marketing organization, rank may be different than a level in a placement or enrollment tree. While level refers generally to a member's position at the time they are recruited into the multi-level marketing organization, rank generally refers to sales and recruiting goals achieved by a member.

At step 44, a matching bonus may be determined. The participant 12 may be eligible for a matching bonus if he reaches a certain rank, for example “executive,” in the multi-level marketing organization. To achieve the “executive” or higher rank in the multi-level marketing organization, a member may be required to meet goals of increasing difficulty. For example, to achieve the rank of “executive,” the member may have to have a minimum of 2,000 GV in his lesser leg for a predetermined period, such as one week. The member may also meet a goal requiring that a distributor in the member's enrollment tree have reached a certain rank in the multi-level marketing organization.

The matching bonus or enrollment tree bonus may be based on the team bonuses earned by any of the members of the participant's 12 enrollment tree 10. For example, the participant 12 may earn a percentage of the team bonus or placement tree bonus earned by members 14a and 14b. The participant 12 may also earn the same percentage of the team bonus earned by members 16a and 16b. In certain embodiments, the matching bonus earned by participant 12 may be based on the sales of any member in his enrollment tree 10, regardless of level. Thus, the enrollment tree bonus of participant 12 may be based on team bonuses of members at level 2 of the enrollment tree 10 as well as level 9 of enrollment tree 10 (not shown). By paying to unlimited depth, compression of the enrollment tree 10 may be eliminated. In certain embodiments, a participant must have reached the rank of executive, be active, and have 200 units in PV to be eligible to receive the matching bonus. The matching bonus may be limited to matching a maximum portion of each placement tree bonus earned by members of the enrollment tree 10 or on an overall cap. In some embodiments, the participant 12 may receive a percentage on the first $2,500 of each team bonus paid to members of the participant's 12 enrollment tree. Any suitable amount of team bonus matched or percentage paid may be used consistent with the teachings of the present disclosure.

The team bonus and the matching bonus are distributed at step 46. In certain embodiments, each week the team bonus may be distributed to a member 14a and the matching bonus may be distributed to the participant 12.

Computing a Matching Bonus for an MLM Participant

FIG. 4 is a somewhat simplified flow diagram illustrating method 50 of computing a matching bonus for the participant 12. It should be understood that method 50 shown in FIG. 4 is for illustrative purposes only and that any other suitable method or sub-method could be used in conjunction with or in lieu of method 50 according to one embodiment of the present disclosure. It should also be understood that the steps of method 50 could be performed in any suitable order or manner.

The method 50 begins at step 52 where a commissionable volume of sales is determined. The commissionable volume of sales may be profits generated from sales made by each of the distributors in the multi-level marketing sales force during a particular time period, such as a week. At step 54, a collective team bonus amount may be determined. The collective team bonus amount may be the combined amount of each eligible member's team bonus. At step 56, a collective general bonus amount may be determined.

The collective general bonus amount may include a preferred customer bonus, a fast start bonus, a business builder bulk order bonus, and a team leader bonus. Each of theses bonuses may be earned if a participant achieves a certain threshold of PV and/or GV. The threshold levels may be set and modified by the company providing the products and/or services. For example, a participant may earn a preferred customer bonus on the PV amount of all purchases made by preferred customers. A fast start bonus may be earned if a participant is active and has 100 PV, then the participant may earn a percentage bonus on the PV amount of the first order placed by each distributor that he personally sponsors. A business builder bulk order bonus may be earned by an active and qualified participant with 100 PV. This bonus may be a percentage bonus on the PV amount of business builder bulk orders placed by a personally sponsored distributor. The team leader bonus may be earned if the participant is active and qualified with a threshold in PV, such as 100 units. If these conditions are met, the participant may be eligible to earn a specific amount each time a member personally sponsored by the participant 12 reaches a new rank in the multi-level marketing organization. For example, the participant 12 may earn a $25 bonus if the sales and recruiting efforts of member 14a qualify member 14a to move from a rank 4 to a rank 5.

A matching bonus pool is determined at step 58. The matching bonus pool may be equal to a certain percentage of the commissionable volume over a given time period. For example, over a given week the multi-level marketing sales force may have a commissionable volume of sales profits for the company equal to approximately $300,000. In certain embodiments, the company may wish to pay out 50% of the commissionable volume as bonuses to its multi-level marketing sales force, which would equal $150,000 in this example. The matching bonus pool may be determined by taking 50% or more of the commissionable volume and subtracting the collective general bonus amount and the collective team bonus amount to be paid to the multi-level marketing sales force. Thus, if the company is to pay out $25,000 in collective general bonuses in a given week and $75,000 in collective team bonuses in the same week, the matching bonus pool would be $50,000 computed as (0.5×$300,000−($25,000+$75,000)).

In certain embodiments, the combined collective general bonus amount and the collective team bonus amount may equal the predetermined percentage of the commissionable volume (50%), leaving nothing in the matching bonus pool. In other circumstances, there may be a small amount left in the matching bonus pool. In these circumstances, the company may determine a minimum amount to pay out as matching bonuses. For example, the company may determine the minimum amount by awarding the participant 25% of each dollar paid in team bonuses to each member of the enrollment tree 10, other than the participant 12.

At step 60, a percentage may be determined. The percentage may be a fixed or a floating percentage. In certain embodiments, the percentage is a floating percentage. This floating percentage may be computed by dividing the matching bonus pool by the collective team bonus amount earned by the multi-level marketing sales force. Continuing with the same example, the floating percentage would be 66.7%—computed by dividing $50,000 by $75,000. The floating percentage may change from week to week depending on the sales and the bonuses earned by the multi-level marketing sales force. At step 62, each eligible participant, such as participant 12, may be paid $0.667 on each dollar paid in team bonuses to each member in the enrollment tree 10, other than the participant 12, and the method 50 ends.

By providing matching bonuses based on the sales of members of a participant's enrollment tree, the company rewards multi-level marketing plan participants for developing their respective enrollment tree legs by personally recruiting others in the plan. This may create incentive to recruit others thereby adding value to the company by enrolling additional individuals into the plan that may sell the company's products and/or services. This incentive is consistent regardless whether a participant has been fortuitously placed in a lucrative position in the placement tree 18.

System for Computing and Distributing Compensation

FIG. 5 is a schematic diagram of internal components of a computer system 70 capable of performing the calculations and determinations described herein. The illustrated computer system 70 may also determine the amounts to distribute to each MLM member as compensation. For example, the system may determine an amount to distribute as a matching bonus to a particular participant.

Each computer system 70 typically contains a bus 72, where a bus is a set of hardware lines used for data transfer among the components of a computer system 70. The bus 72 is essentially a shared conduit that connects different elements or components of a computer system 70 (e.g., processor, disk storage, memory, input/output ports, network ports, etc.) and enables the transfer of information between the elements. Attached to system bus 72 is an I/O (input/output) device interface 74 for connecting various input and output devices (e.g., displays, printers, speakers, etc.) to the computer. A network interface 78 allows the computer system 70 to connect to various other devices attached to a network. Memory 80 may provide volatile storage for computer software instructions 82 and data 84 used to implement embodiments of the present disclosure. Disk storage 86 may provide non-volatile storage for computer software instructions 88 and data 90 used to implement embodiments of the present disclosure. A central processor unit 76 is also attached to bus 72 and provides for the execution of computer instructions.

As will be appreciated by one skilled in the art, the present disclosure may be embodied as a system, method or computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a circuit, module or system. Furthermore, embodiments of the present disclosure may take the form of a computer program product embodied in any tangible medium of expression having computer-usable program code embodied in the medium.

Any combination of one or more computer usable or computer readable mediums(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on a single computer, partly on a single computer as a stand-alone software package, partly on single computer and partly on a remote computer or entirely on the remote computer or server. In the latter scenario, the remote computer may be connected to the single computer through any type of network, including a local area network (LAN) or a wide area network (WAN), or the connection may be made to an external computer (for example, through the Internet using an Internet Service Provider). The computer usable program code may be transmitted using any appropriate medium, including but not limited to wireless, wireline, optical fiber cable, radio frequency, etc.

These computer program instructions may also be stored in a computer-readable medium, as described above, that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Computer or computing device broadly refers to any kind of device that receives input data, processes that data through computer instructions in a program, and generates output data. Such computer can be a hand-held device, laptop or notebook computer, desktop computer, minicomputer, mainframe, server, mobile phone, smart phone, personal digital assistant, other device, or any combination thereof.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of compensating a participant of a multi-level marketing plan, comprising:
classifying a participant as occupying a top position of a placement tree associated with the participant, the placement tree having a binary structure;
classifying the participant as occupying a top position of an enrollment tree associated with the participant, the enrollment tree having a unilevel structure where each member personally sponsored by the participant occupies a first enrollment tree level and each member personally sponsored by each member personally sponsored by the participant occupies a second enrollment tree level;
classifying a first distributor as occupying a first lower position of the placement tree associated with the participant and as occupying a first lower position of the enrollment tree associated with the participant;
determining a team bonus of the first distributor based on revenue generated by sales made by a plurality of members of the placement tree associated with the participant down line from the first distributor;
determining a matching bonus based on the team bonus of the first distributor, the first distributor occupying any level of the enrollment tree associated with the participant;
distributing the team bonus to the first distributor; and
distributing the matching bonus to the participant.

2. The method of claim 1, further comprising:
classifying a second distributor as occupying a second lower position of the placement tree associated with the participant and as occupying a second lower position of the enrollment tree associated with the participant;
determining a second team bonus of the second distributor based on revenue generated by sales made by a plurality of members of the placement tree associated with the participant down line from the second distributor;
determining the matching bonus based on the team bonus of the second distributor, the second distributor occupying any level of the enrollment tree associated with the participant, the matching bonus comprising a percentage of the team bonus of the first distributor and the same percentage of the second team bonus of the second distributor; and
distributing the second team bonus to the second distributor.

3. The method of claim 1, wherein the matching bonus is a percentage of each team bonus earned by each member of the enrollment tree associated with the participant down line from the participant.

4. The method of claim 3, further comprising:
determining a commissionable volume of sales of a multi-level marketing sales force over a predetermined period;
determining a collective team bonus amount of the sales of the multi-level marketing sales force over the predetermined period;
determining a collective general bonus amount of the sales of the multi-level marketing sales force over the predetermined period;
determining a matching bonus pool, the matching bonus pool being a portion of the commissionable volume less the collective general bonus amount and the collective team bonus amount; and
wherein the percentage is determined by dividing the matching bonus pool by the collective team bonus amount.

5. The method of claim 1, wherein each week the distributor is eligible to receive the team bonus and the participant is eligible to receive the matching bonus.

6. The method of claim 1, further comprising:
determining a greater leg and a lesser leg of a placement tree associated with the distributor, the greater leg having members with more revenue generated by sales than the revenue generated by sales of members of the lesser leg; and
wherein the team bonus is a portion of the revenue generated by the sales of the members of the lesser leg.

7. The method of claim 1, wherein the revenue generated by sales comprises revenue generated by sales of nutritional supplements.

8. The method of claim 1, wherein the revenue generated by sales comprises revenue generated by sales of appliances.

9. The method of claim 1, further comprising distributing a team leader bonus to the participant each time a member of the enrollment tree associated with the participant reaches a higher rank in the multi-level marketing plan.

10. A system to compensate a participant of a multi-level marketing plan, comprising:
a memory element; and
a processor coupled to the memory element, the processor operable to perform operations comprising:
classifying a participant as occupying a top position of a placement tree associated with the participant, the placement tree having a binary structure;
classifying the participant as occupying a top position of an enrollment tree associated with the participant, the enrollment tree having a unilevel structure where each member personally sponsored by the participant occupies a first enrollment tree level and each member personally sponsored by each member personally sponsored by the participant occupies a second enrollment tree level;
classifying a first distributor as occupying a first lower position of the placement tree associated with the participant and as occupying a first lower position of the enrollment tree associated with the participant;
determining a team bonus of the first distributor based on revenue generated by sales made by a plurality of members of the placement tree associated with the participant down line from the first distributor; and
determining a matching bonus based on the team bonus of the first distributor, the first distributor occupying any level of the enrollment tree associated with the participant;
distributing the team bonus to the first distributor; and
distributing the matching bonus to the participant.

11. The system of claim 10, wherein the processor is further operable to:
classify a second distributor as occupying a second lower position of the placement tree associated with the participant and as occupying a second lower position of the enrollment tree associated with the participant;
determine a second team bonus for the second distributor based on revenue generated by sales made by a plurality of members of the placement tree associated with the participant down line from the second distributor;
determine the matching bonus based on the team bonus of the second distributor, the second distributor occupying any level of the enrollment tree associated with the participant, the matching bonus comprising a percentage of the team bonus of the first distributor and the same percentage of the second team bonus of the second distributor; and
distribute the second team bonus to the second distributor.

12. The system of claim 10, wherein the matching bonus is a percentage of each team bonus earned by each member of the enrollment tree associated with the participant down line from the participant.

13. The system of claim 12, wherein the processor is further operable to:
determine a commissionable volume of sales of a multi-level marketing sales force over a predetermined period;
determine a collective team bonus amount of the sales of the multi-level marketing sales force over the predetermined period;
determine a collective general bonus amount of the sales of the multi-level marketing sales force over the predetermined period;
determine a matching bonus pool, the matching bonus pool being a portion of the commissionable volume less the collective general bonus amount and the collective team bonus amount; and
wherein the percentage is determined by dividing the matching bonus pool by the collective team bonus amount.

14. The system of claim 10, wherein each week the distributor is eligible to receive the team bonus and the participant is eligible to receive the matching bonus.

15. The system of claim 10, wherein the processor is further operable to:
determine a greater leg and a lesser leg of a placement tree associated with the distributor, the greater leg having members with more revenue generated by sales than the revenue generated by sales of members of the lesser leg; and
wherein the team bonus is a portion of the revenue generated by the sales of the members of the lesser leg.

16. The system of claim 10, wherein the revenue generated by sales comprises revenue generated by sales of nutritional supplements.

17. The system of claim 10, wherein the revenue generated by sales comprises revenue generated by sales of appliances.

18. The system of claim 10, wherein the processor is further operable to distribute a team leader bonus to the participant each time a member of the enrollment tree associated with the participant reaches a higher rank in the multi-level marketing plan.

19. A method of compensating a participant of a multi-level marketing plan, comprising:
classifying a participant as occupying a top position of a placement tree associated with the participant, the placement tree having a binary structure;
classifying the participant as occupying a top position of an enrollment tree associated with the participant, the enrollment tree having a unilevel structure where each member personally sponsored by the participant occupies a first enrollment tree level and each member personally sponsored by each member personally sponsored by the participant occupies a second enrollment tree level;
classifying a first distributor as occupying a first lower position of the placement tree associated with the participant and as occupying a first lower position of the enrollment tree associated with the participant;
determining a team bonus of the first distributor based on revenue generated by sales made by a plurality of members of the placement tree associated with the participant down line from the first distributor;
determining a greater leg and a lesser leg of a placement tree associated with the distributor, the greater leg having members with more revenue generated by sales than the revenue generated by sales of members of the lesser leg; and
wherein the team bonus is based on the revenue generated by the sales of the members of the lesser leg;
determining a matching bonus based on the team bonus of the first distributor, the first distributor occupying any level of the enrollment tree associated with the participant, the matching bonus being a portion of each team bonus earned by each member of the enrollment tree of the participant down line from the participant;
distributing the team bonus to the first distributor; and
distributing the matching bonus to the participant.

20. The method of claim 19, further comprising:
classifying a second distributor as occupying a second lower position of the placement tree associated with the participant and as occupying a second lower position of the enrollment tree associated with the participant;
determining a second team bonus for the second distributor based on revenue generated by sales made by a plurality of members of the placement tree associated with the participant down line from the second distributor;
determining the matching bonus based on the team bonus of the second distributor, the second distributor occupying any level of the enrollment tree associated with the participant, the matching bonus comprising a percentage of the team bonus of the first distributor and the same percentage of the second team bonus of the second distributor; and
distributing the second team bonus to the second distributor.
